(19) United States
(12) Patent Application Publication
(10) Pub. No.: US 2026/0179531 A1
(43) Pub. Date: Jun. 25, 2026

(54) DISPLAY APPARATUS FOR COMPENSATING ABNORMAL LIGHT SOURCE BY ADJUSTING PULSE WIDTH MODULATION

(71) Applicant: Novatek Microelectronics Corp., Hsinchu (TW)

(72) Inventor: Yi-Chao Huang, Tainan City (TW)

(73) Assignee: Novatek Microelectronics Corp., Hsinchu (TW)

(21) Appl. No.: 19/000,785

(22) Filed: Dec. 24, 2024

(51) Int. Cl. G09G 3/32

(52) U.S. Cl. CPC G09G 3/32; G09G 2320/0228; G09G 2380/10

(57) ABSTRACT

An embodiment of the invention provides a display apparatus including a light source module and a processing circuit. The light source module includes a plurality of normal light-emitting diode (LED) units and a target LED unit. The processing circuit is coupled to the light source module. The processing circuit is configured to select at least one normal LED unit, and adjust at least one of a duty cycle and a current value of a pulse width modulation signal for driving the at least one normal LED unit to compensate the target LED unit. The at least one normal LED unit is adjacent to the target LED unit.

### BACKGROUND

### Technical Field

The invention relates to an electronic apparatus, more specifically, to a display apparatus.

### Description of Related Art

A display apparatus using light-emitting diodes (LEDs) as light source modules may be applied to in-vehicle systems. In some cases, the brightness of the light source modules may be insufficient due to abnormal LEDs, resulting in an unclear display. However, it is important for the in-vehicle systems to prevent drivers from ignoring important graphical information on the display. The reduction in brightness of the light source modules due to abnormal LEDs must be compensated for.

### SUMMARY

The invention is directed to a display apparatus, capable of compensating abnormal light-emitting diode (LED) units to clearly display images.

An embodiment of the invention provides a display apparatus including a light source module and a processing circuit. The light source module includes a plurality of normal LED units and a target LED unit. The processing circuit is coupled to the light source module. The processing circuit is configured to select at least one normal LED unit, and adjust at least one of a duty cycle and a current value of a pulse width modulation signal for driving the at least one normal LED unit to compensate the target LED unit. The at least one normal LED unit is adjacent to the target LED unit.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a display apparatus according to an embodiment of the invention.

FIG. 2 is a schematic diagram illustrating a specified region of a light source module according to an embodiment of the invention.

FIG. 3 is a schematic diagram illustrating the duty cycle is adjusted according to an embodiment of the invention.

FIG. 4 is a schematic diagram illustrating the current value is adjusted according to an embodiment of the invention.

FIG. 5 illustrates some icons that are displayed on the display apparatus according to an embodiment of the invention.

### DESCRIPTION OF THE EMBODIMENTS

Embodiments are provided below to describe the disclosure in detail, though the disclosure is not limited to the provided embodiments, and the provided embodiments can be suitably combined. The term “coupling/coupled” or “connecting/connected” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” In addition, the term “signal” can refer to a current, a voltage, a charge, a temperature, data, electromagnetic wave or any one or multiple signals.

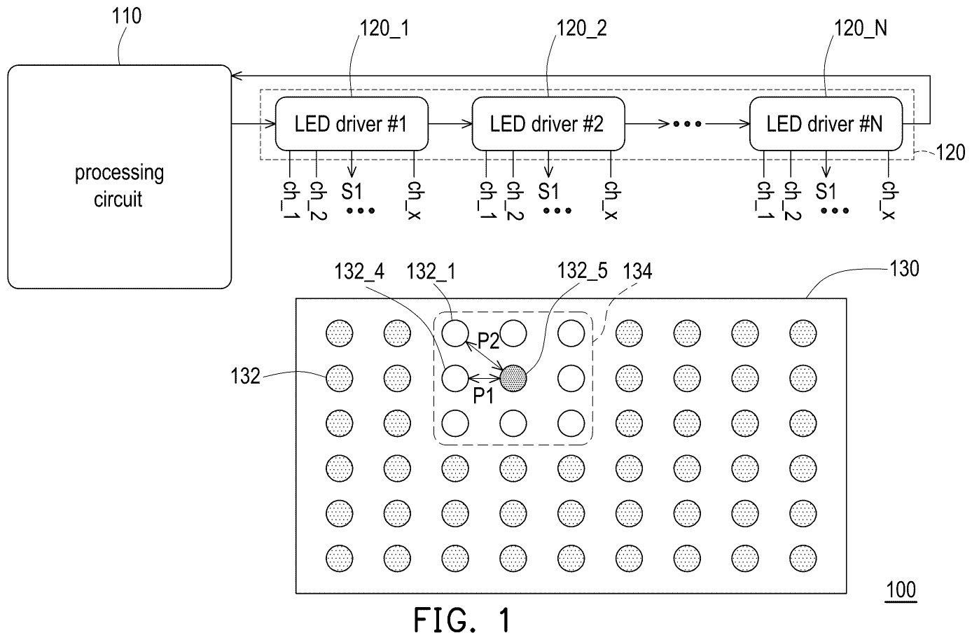

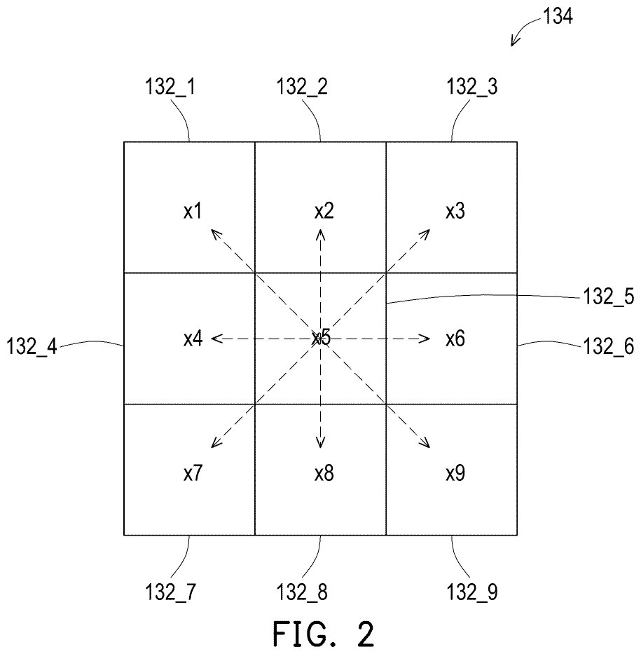

FIG. 1 is a schematic diagram illustrating a display apparatus according to an embodiment of the invention. FIG. 2 is a schematic diagram illustrating a specified region of a light source module according to an embodiment of the invention, wherein the specified region 134 includes a broken zone. Referring to FIG. 1 and FIG. 2, the display apparatus 100 includes a processing circuit 110, a driving circuit 120, and a light source module 130. The processing circuit 110 is coupled to the light source module 130. The driving circuit 120 is coupled to the processing circuit 110 and the light source module 130.

The driving circuit 120 includes a plurality of light-emitting diode (LED) drivers 120_1 to 120_N, wherein N is an integer larger than 2. The light source module 130 includes a plurality of LED units 132 arranged in an array. Each of the LED units 132 includes one or more LEDs. The driving circuit 120 is configured to output a pulse width modulation (PWM) signal S1 to drive the respective LED units 132 to emit light.

In the present embodiment, the processing circuit 110 may be a timing controller integrated circuit (IC), and the LED drivers 120_1 to 120_N may be LED driver ICs having local dimming function. The light source module 130 may serve as a backlight module.

The processing circuit 110 automatically detects whether any LED unit is abnormal, and locates the position of the abnormal LED unit on the light source module 130. The processing circuit 110 collects the error information from the LED drivers 120_1 to 120_N. The error information includes the status of the LED unit, e.g. open or short, and its position.

For example, the processing circuit 110 can detect whether the LED unit 132_5 in the region 134 is open or short via the driving channel Ch_2 of the LED driver 120_2, and locates its position. Once the LED unit 132_5 is open or short, the processing circuit 110 determines the LED unit 132_5 as a broken zone. The processing circuit 110 selects at least one normal LED unit 132_1˜132_4 and 132_6˜132_9, and adjusts at least one of a duty cycle and a current value of the PWM signals for driving the at least one normal LED unit to compensate the abnormal LED unit (target LED unit) 132_5. The normal LED units 132_1˜132_4 and 132_6˜132_9 are adjacent to the abnormal LED unit 132_5. Therefore, the processing circuit 110 compensates the abnormal LED unit 132_5 by at least one of the normal LED units 132_1˜132_4 and 132_6˜132_9.

To be specific, the processing circuit 110 may compensate the abnormal LED unit 132_5 based on the following formula (1):

$${{x}^{´}}_{i} = {x}_{i} + {α}_{i} \cdot {x}_{5} \qquad ( 1 )$$

where x5 is the duty cycle or the current value of the PWM signal S1 for driving the abnormal LED unit 132_5; xi′ is the compensation duty cycle or the compensation current value of the normal LED unit, and xi is the duty cycle or the current value of the normal LED unit, wherein i=1˜4, 6˜9; and the parameter αi is an adjustable gain. As a result, the brightness of at least one normal LED unit can be enhanced to compensate the brightness of the abnormal LED unit 132_5.

For duty cycle compensation, the compensation duty cycle xi′ does not exceed the maximum value specified by the LED driver ICs. For example, the PWM signal S1 may be a digital signal of 16 bits, and the PWM value does not exceed the maximum value 65535. The maximum value 65535 is not intended to limit the invention.

In the present embodiment, PWM_DC=(PWM_V/PWM_MAX)×100%, where PWM_DC is the PWM duty cycle, PWM_V is the PWM value, and PWM_MAX is the maximum PWM value.

For current compensation, the compensation current value xi′ also does not exceed the maximum value specified by the LED driver ICs. For example, each driving channel of the LED drivers 120_1 to 120_N supports the maximum value 60 milliampere (mA), and the compensation current value xi′ does not exceed the maximum value 60 mA. The maximum value 60 mA is not intended to limit the invention.

In an embodiment, four adjacent LED units 132_2, 132_4, 132_6, 132_8 (first part) at up, down, left and right (first arrangement) of the abnormal LED unit 132_5 can be used to compensate the abnormal LED unit 132_5. In another embodiment, four adjacent LED units 132_1, 132_3, 132_7, 132_9 (second part) at left-up, right-up, left-down, and right-down (second arrangement) of the abnormal LED unit 132_5 can be used to compensate the abnormal LED unit 132_5. In another embodiment, eight adjacent LED units 132_1˜132_4 and 132_6˜132_9 surrounding the abnormal LED unit 132_5 can be used to compensate the abnormal LED unit 132_5. The number and position of the normal LED units used to compensate the abnormal LED unit 132_5 do not limit the invention.

In FIG. 1, the first arrangement includes a first pixel pitch P1 between the abnormal LED unit 132_5 and the normal LED unit 132_4, and the second arrangement comprises a second pixel pitch P2 between the abnormal LED unit 132_5 and the normal LED unit 132_1. The second pixel pitch P2 is larger than the first pixel pitch P1.

Regarding hardware structures, the processing circuit 110 may be a processor having computational capability. Alternatively, the processing circuit 110 may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). In addition, enough teaching, suggestion, and implementation illustration for hardware structures of the processing circuit 110, the driving circuit 120, and the light source module 130 could be obtained with reference to common knowledge in the related art.

In the present embodiment, the display apparatus 100 may be an electronic device having a display function, a touch sensing function and/or a fingerprint sensing function. In an embodiment, the display apparatus 100 may be, but not limited to, a smartphone, a non-smart phone, a wearable electronic device, a tablet computer, a personal digital assistant, a notebook and other portable electronic devices that could operate independently and have the display function, the touch sensing function and/or the fingerprint sensing function. In an embodiment, the display apparatus 100 may be, but not limited to, a portable or un-portable electronic device in a vehicle intelligent system. In an embodiment, the display apparatus 100 may be, but not limited to, intelligent home appliances such as, a television, a computer, a refrigerator, a washing machine, a telephone, an induction cooker, a table lamp and so on.

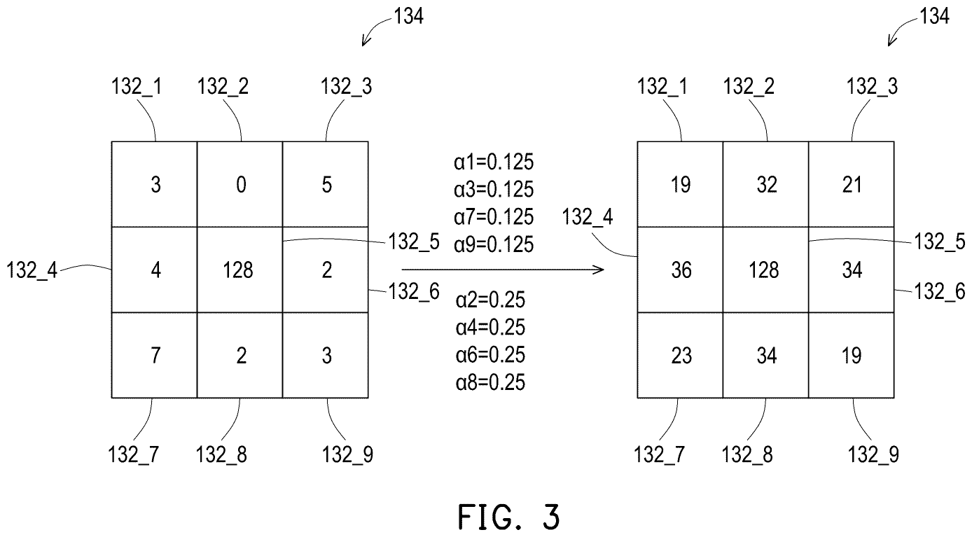

FIG. 3 is a schematic diagram illustrating the duty cycle is adjusted according to an embodiment of the invention. Referring to FIG. 3, the PWM values are marked on the corresponding LED units. Assuming that the LED unit 132_5 is detected to be abnormal, the eight normal LED units 132_1˜132_4 and 132_6˜132_9 surrounding the abnormal LED unit 132_5 are used to compensate the abnormal LED unit 132_5. The processing circuit 110 sets cycle gains α1˜α4 and α6˜α9 for the normal LED units 132_1˜132_4 and 132_6˜132_9, and calculates a compensation duty cycle xi′ based on the set cycle gains α1˜α4 and α6˜α9.

In the present embodiment, the cycle gains α1, α3, α7, α9 are set as 0.125 (second gain value) for the LED units 132_1, 132_3, 132_7, 132_9, and the cycle gains α2, α4, α6, α8 are set as 0.25 (first gain value) for the LED units 132_2, 132_4, 132_6, 132_8. In an embodiment, the processing circuit 110 may set different gain values for the plural normal LED units. In an embodiment, the processing circuit 110 may set the same gain value for the plural normal LED units. The gains can be set as the same or to be different for the LED units, and the set gain values are not intended to limit the invention. The PWM value xi′ can be calculated according to the formula (1) to compensate the LED unit 132_5.

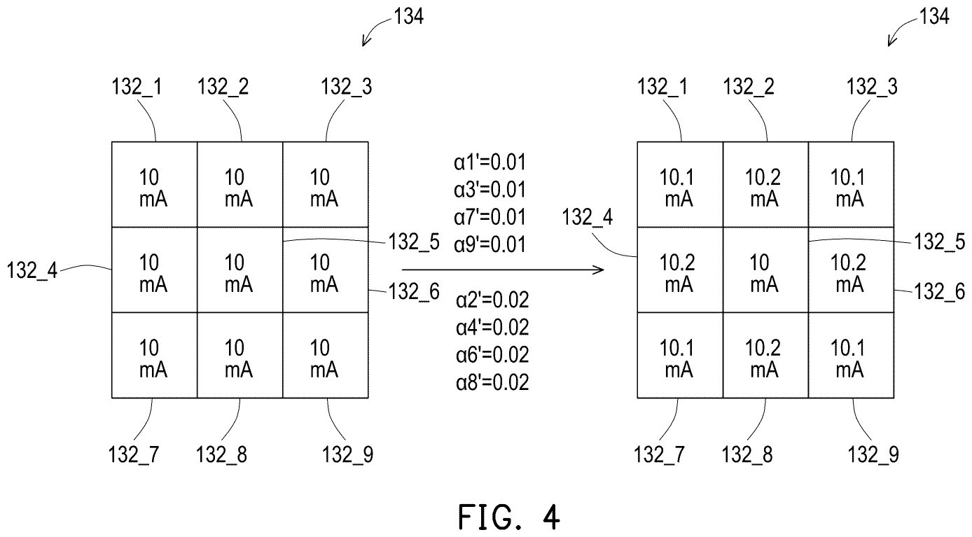

FIG. 4 is a schematic diagram illustrating the current value is adjusted according to an embodiment of the invention. Referring to FIG. 4, the current values are marked on the corresponding LED units. In the present embodiment, still assuming that the LED unit 132_5 is abnormal, the eight normal LED units 132_1˜132_4 and 132_6˜132_9 surrounding the abnormal LED unit 132_5 are also used to compensate the abnormal LED unit 132_5. The processing circuit 110 sets current gains α1′˜α4′ and α6′˜α9′ for the normal LED units 132_1˜132_4 and 132_6˜132_9, and calculates a compensation current value xi′ based on the set current gains α1′˜α4′ and α6′˜α9′.

In the present embodiment, the current gains α1′, α3′, α7′, α9′ are set as 0.01 for the LED units 132_1, 132_3, 132_7, 132_9, and the current gains α2′, α4′, α6′, α8′ are set as 0.02 for the LED units 132_2, 132_4, 132_6, 132_8. The current value xi′ can be calculated according to the formula (1) to compensate the LED unit 132_5.

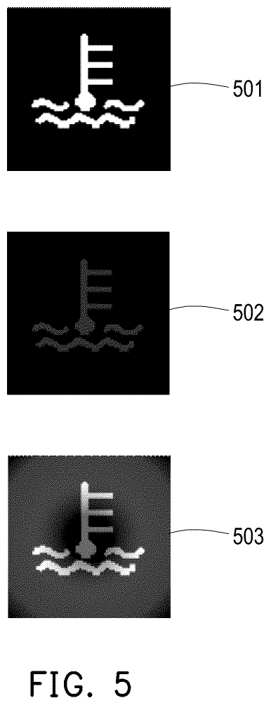

FIG. 5 illustrates some icons that are displayed on the display apparatus according to an embodiment of the invention. Referring to FIG. 5, the icon 501 is a case that all the LED units 132_1˜132_9 are normal, and the icon 502 is a case that the LED unit 132_5 is abnormal. The icon 503 is a case that the LED unit 132_5 is compensated. The brightness of at least one normal LED unit 132_1˜132_4 and 132_6˜132_9 can be enhanced to compensate the brightness of the abnormal LED unit 132_5.

In summary, in the embodiments of the invention, a display apparatus is provided to improve the problem of an unclear display caused by insufficient brightness of the light source module due to abnormal LEDs. The display apparatus can be applied to in-vehicle systems to improve safety and prevent drivers from ignoring important image information on the display apparatus.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A display apparatus, comprising:
a light source module, comprising a plurality of normal light-emitting diode (LED) units and a target LED unit; and
a processing circuit, coupled to the light source module, and configured to select at least one normal LED unit, and adjust at least one of a duty cycle and a current value of a pulse width modulation signal for driving the at least one normal LED unit to compensate the target LED unit, wherein the at least one normal LED unit is adjacent to the target LED unit,
wherein the plural normal LED units are selected to compensate the target LED unit, and the processing circuit sets a first gain value for a first part of the plural normal LED units, and sets a second gain value for a second part of the plural normal LED units, wherein the first gain value is larger than the second gain value; and
a first pixel pitch between the target LED unit and each of the first part of the plural normal LED units is smaller than a second pixel pitch between the target LED unit and each of the second part of the plural of normal LED units.

2. The display apparatus according to claim 1, further comprising:
a driving circuit, coupled to the processing circuit and the light source module, and configured to output the pulse width modulation signal to drive the at least one normal LED unit.

3. The display apparatus according to claim 1, wherein the processing circuit sets a cycle gain for the at least one normal LED unit, and calculates a compensation duty cycle based on the set cycle gain.

4. The display apparatus according to claim 1, wherein the processing circuit sets a current gain for the at least one normal LED unit, and calculates a compensation current value based on the set current gain.

5. The display apparatus according to claim 1, wherein the plural normal LED units are selected to compensate the target LED unit, and the processing circuit sets different gain values for the plural normal LED units.

6. The display apparatus according to claim 1, wherein the plural normal LED units are selected to compensate the target LED unit, and the processing circuit sets a same gain value for the plural normal LED units.

7. (canceled)

8. The display apparatus according to claim 1, wherein the first part of the plural normal LED units is adjacent to the target LED unit in a first arrangement, and the second part of the plural normal LED units is adjacent to the target LED unit in a second arrangement different from the first arrangement.

9. The display apparatus according to claim 8, wherein the first arrangement comprises the first pixel pitch between the target LED unit and the normal LED unit, the second arrangement comprises the second pixel pitch between the target LED unit and the normal LED unit.

10. The display apparatus according to claim 1, wherein the target LED unit is an abnormal LED unit, which is open or short.
